(19) United States
(12) Patent Application Publication
(10) Pub. No.: US 2012/0215882 A1
(43) Pub. Date: Aug. 23, 2012

(54) CONTENT MANAGEMENT METHOD, MANAGEMENT STORAGE DEVICE, AND NON-TRANSISTORY CONTENT MANAGEMENT COMPUTER PROGRAM PRODUCT

(75) Inventor: Satoru GOTO, Nagoya-shi (JP)

(73) Assignee: Buffalo Inc., Nagoya-shi (JP)

(21) Appl. No.: 13/362,925

(22) Filed: Jan. 31, 2012

(30) Foreign Application Priority Data
Jan. 31, 2011 (JP) P2011-019184

(51) Int. Cl. G06F 15/16

(52) U.S. Cl. 709/217

(57) ABSTRACT

A content management method, apparatus and computer program product cooperate to transmit from a management storage device a connection list request that requests a list of connection contents stored in a connection storage device connected to the management storage device via a public network to the connection storage device. A connection storage device receives the connection list request, and transmits the list of connection contents. The management storage device receives and arranges the list of connection contents, and converts a protocol corresponding to the connection storage device into a protocol corresponding to a local device, and transmits a consolidated content list to the local device.

### CROSS REFERENCE TO RELATED APPLICATION

This application is based upon and claims the benefit of priority from Japanese Patent Application No.2011-019184, filed on Jan. 31, 2011 the entire content of which is incorporated herein by reference.

### BACKGROUND

1. Field

The present disclosure relates to a management storage device, a content management method for managing a content stored in a connection storage device connected via a public network to the management storage device, and a non-transitory content management computer program product for managing such contents.

2. Description of Related Art

With the growing use of digital contents, such as images and sounds, it is desired to share the content among a plurality of storage resources as well as storing the content in a local storage resource and using it. In recent years, the technology of using a content in a local network by making use of DLNA equipment, for example, is becoming popular. For example, the content stored in DMS (Digital Media Server) is played in DMP (Digital Media Player) (for example, see Japanese Unexamined Patent Application Publication No. 2008-41120).

Further, there is provided a conference support system equipped with a PC and a server connected via a local network, wherein the content stored in the server is used in the PC (for example, see Japanese Unexamined Patent Application Publication No. 2006-12085). For example, a content request requesting the content related to a project considered in the conference is transmitted from the PC in the conference room to the server. The server has a file space that stores the content. The file space corresponds to the PC in each conference room. In response to a content request, the server transmits the requested project content to the file space of the PC, which transmitted the content request, and stores the content in the file space.

### SUMMARY

However, in general, the content is stored not only in a storage connected via the local network, but also in a storage connected via a public network, and there is a need of user to acquire the content via the public network.

The content acquired via the public network is described in a language such as HTML, XML, and JSON, for example. On the other hand, it is assumed that local devices such as DMP do not have a function of using the content described in these languages. In such a case, the local device cannot use the content connected to the public network.

In light of the above-described circumstances recognized by the present inventors, the present disclosure provides, among other things, a content management method which enables a content stored in a connection storage device connected to a management storage device via a public network to be used in a management storage device and a local device connected to the management storage device via a local network, and also to provide a management storage device and a non-transitory content management computer program product.

There is a contents management method as one embodiment that includes transmitting from a management storage device a connection list request that requests a list of connection contents stored in a connection storage device connected to the management storage device via a public network to the connection storage device;

receiving by the connection storage device the connection list request, and transmitting the list of connection contents;

receiving at the management storage device the list of connection contents, and arranging the received list of connection contents in a lower hierarchy of a directory indicating the connection storage device arranged in a lower hierarchy of a directory indicating the management storage device; and

converting at the management storage device a protocol corresponding to the connection storage device into a protocol corresponding to a local device to be connected via a local network with the management storage device, and transmitting a consolidated content list including the list of connection contents to the local device.

According to the content management method, the management storage device acquires a list of connection contents stored in the connection storage device, and transmits a consolidated content list including the list of connection contents to a local device via a protocol corresponding to a local device. Thus, the local device connected to the management storage device via the local network can use the list of connection contents. It is noted that the consolidated content list may be configured only by the list of connection contents acquired from the connection storage device, or may be configured by including a list of management content stored in the management storage device and the list of connection contents.

Such protocol conversion, for example, converts the list of connection contents acquired from the connection storage device from a communications protocol or a language format supported by the connection storage device, into a communications protocol or a language format supported by the local device. For example, in a case where the local device is DLNA equipment, if the management storage device converts the protocols supported by HTTP and DLNA equipment, the connection content can be used in the local device as well.

Further, according to the content management method, even if a management storage device is not equipped with a predetermined memory area storing the content, the content of the connection storage device connected via a network can be operated as if the content was stored in the management storage device. Such a management storage device that is not equipped with a predetermined memory area exhibits a function of relaying the content between the connection storage device and the local device.

It is noted that the “content” referring to here includes not only digitalized image and audio but also a text file and a data file such as a WORD file and EXCEL file. The content list may have a tree-like structure in which a plurality of items are hierarchized. For example, the content list may indicate content names, or the names of folders in which contents are stored.

Further, a directory indicating the connection storage device may be configured to create its sub-directories beforehand at a predetermined timing such as when the management storage device is connected to the connection storage device, or may be configured to create its sub-directories when the list of connection contents is acquired from the connection storage device.

It is noted that the management storage device and the connection storage device may be configured such that the both storage devices arranged within the same network, or the both storage devices are arranged in different network s, and the respective network are connected via a relay server, etc. The management storage device is a system configured to manage the directories of the hierarchical structure.

Further, the connection directory, indicating the connection storage device may be arranged in a predetermined memory area of the management storage device, according to such a configuration, in the management storage device, not only the list of management content stored in the management storage device, but also the list of connection contents, can be operated in a similar manner.

Specifically, for example, in a general PC, file software (such as EXPLORER) configured to move and browse the content is built to enable a user to visually operate to move the content such as by dragging and dropping and/or by copying and pasting. However, such a visual operation is applicable only to the content stored in a predetermined memory area of the management storage device, and performing intuitive operations when browsing the content stored in another storage device, for example, when browsing the content using a Web browser, was difficult. However, by arranging the connection content list in the directory of a predetermined memory area of the management storage device, the content stored in the connection storage device can be operated visually, and the operability can be improved.

It is noted that a sub-directory may be arranged in a lower hierarchy of a root directory of a predetermined memory area of the management storage device, and may be a root directory (such as a D drive), or may be allocated to a root directory as a sub-directory indicating the connection storage device.

According to a method implementation, the method includes transmitting from a management storage device a connection list request that requests a list of connection contents stored in a connection storage device connected to the management storage device via a public network to the connection storage device;

receiving by the connection storage device the connection list request, and transmitting the list of connection contents;

receiving at the management storage device the list of connection contents, and arranging the received list of connection contents in a lower hierarchy of a directory indicating the connection storage device arranged in a lower hierarchy of a directory indicating the management storage device; and

converting at the management storage device a protocol corresponding to the connection storage device into a protocol corresponding to a local device to be connected via a local network with the management storage device, and transmitting a consolidated content list that consolidates the list of connection contents and the list of management contents stored in the management storage device.

According to such a content management method, the local device can acquire the consolidated content list that consolidates the list of connection contents stored in the connection storage device and the list of management content stored in the management storage device, and use the consolidated content list.

For either method discussed above, the respective method may further include transmitting by the local device a connection content request that requests connection content data included in the consolidated content list, to the management storage device;

receiving at the management storage device the connection content request, and transmitting the received connection content request to the connection storage device;

receiving at the connection storage device the connection content request, and transmitting a requested connection content data to the management storage device; and

receiving at the management storage device the connection content data, and transmitting the received connection content data to the local device.

According to the later content management method, the method further includes

transmitting from the local device a management content request that requests management content data contained in the consolidated content list, to the management storage device; and

receiving by the management storage device the management content request, and transmitting the requested management content data to the local device.

According to such a content management method, the local device acquires the consolidated content list that consolidates the list of connection contents stored in the connection storage device and the list of management content stored in the management storage device, and can acquire the content selected from the list of contents. Regardless of whether the content is stored in the management storage device or in the connection storage device, the local device can acquire the content with the same operation without differentiating the two.

A content management method feature includes transmitting from the management storage device a name resolution request to acquire an address of the connection storage device to a name resolution server for executing a name resolution with the connection storage device, in response to the connection list request; and transmitting from the name resolution server the address of the connection storage device, which serves as a name resolution result, to the management storage device, in response to the name resolution request.

According to an embodiment, one aspect includes transmitting from a management storage device a connection list request that requests a list of connection contents stored in a connection storage device connected via a public network to the management storage device to a plurality of the connection storage devices;

receiving at the respective plurality of the connection storage devices the connection list request, and transmitting the list of connection contents to the management storage device;

making at the management storage device each list of connection contents, in a lower hierarchy of a directory indicating the connection storage device arranged in a lower hierarchy of a directory indicating the management storage device;

creating by the management storage device a consolidated content list that consolidates the plurality of connection content lists; and converting at the management storage device a protocol corresponding to the connection storage device into a protocol corresponding to a local device connected via a local network to the management storage device, and transmitting the consolidated content list to the local device.

There is a management storage device as another concept of the present disclosure. The management storage device connected to enable communication via a public network with a connection storage device and connected to enable communication via a local network with a local device, including: a connection list request reception unit that receives a connection list request that requests a list of contents stored in the connection storage device, from the local device;

a list of connection content acquisition unit that acquires the list of connection contents from the connection storage device, in response to the connection list request;

a directory organization unit that arranges the list of connection contents in a lower hierarchy of a directory indicating the connection storage device arranged in a lower hierarchy of a directory indicating the management storage device; and

a content list transmission unit that converts a protocol corresponding to the connection storage device into a protocol corresponding to the local device, and transmits the list of connection contents to the local device.

Further, the connection list request transmitted to the connection storage device from the management storage device may be transmitted in response to the connection list request from the local device, or may be transmitted when the management storage device and connection storage device are connected.

Further, the management storage device as disclosed may also include a record holding unit for temporarily recording the list of connection contents. In such a case, instead of acquiring the list of connection contents from the connection storage device every time a connection list request is received, the management storage device can transmit the list of connection contents recorded in the record holding unit to the local device, which enables shortening of the processing time. For example, in a case where the network connecting the management storage device and connection storage device is comparatively slow, the processing time can be shortened as compared with the case where the list of connection contents is acquired via the network.

A non-transitory content management computer program product having stored therein instructions that when executed by a processing circuit cause the processing circuit to communicate via a public network with a connection storage device and communicate via a local network with a local device, and implement a device comprising:

a connection list request reception unit that receives a connection list request that requests a list of contents stored in the connection storage device, from the local device;

a list of connection content acquisition unit that acquires the list of connection contents from the connection storage device, in response to the connection list request;

a directory organization unit that arranges the list of connection contents in a lower hierarchy of a directory indicating the connection storage device arranged in a lower hierarchy of a directory indicating the management storage device; and

a content list transmission unit that converts a protocol corresponding to the connection storage device into a protocol corresponding to the local device, and transmits the list of connection contents to the local device.

According to the present disclosure, the management storage device and the local device connected to the management storage device via a local network use the content stored in the connection storage device connected to the management storage device via a public network.

### BRIEF DESCRIPTION OF DRAWINGS

FIG. 1 is a block diagram showing the general configuration of a content management system according to a first embodiment.

FIG. 2 is a configuration diagram of a management storage device shown in FIG. 1.

FIG. 3 is a configuration diagram of a connection storage device shown in FIG. 1.

FIG. 4 is a configuration diagram of a local playback device shown in FIG. 1.

FIG. 5 is a diagram showing process of organizing a local directory of a management storage device.

FIG. 6 is a diagram showing process of organizing a local directory.

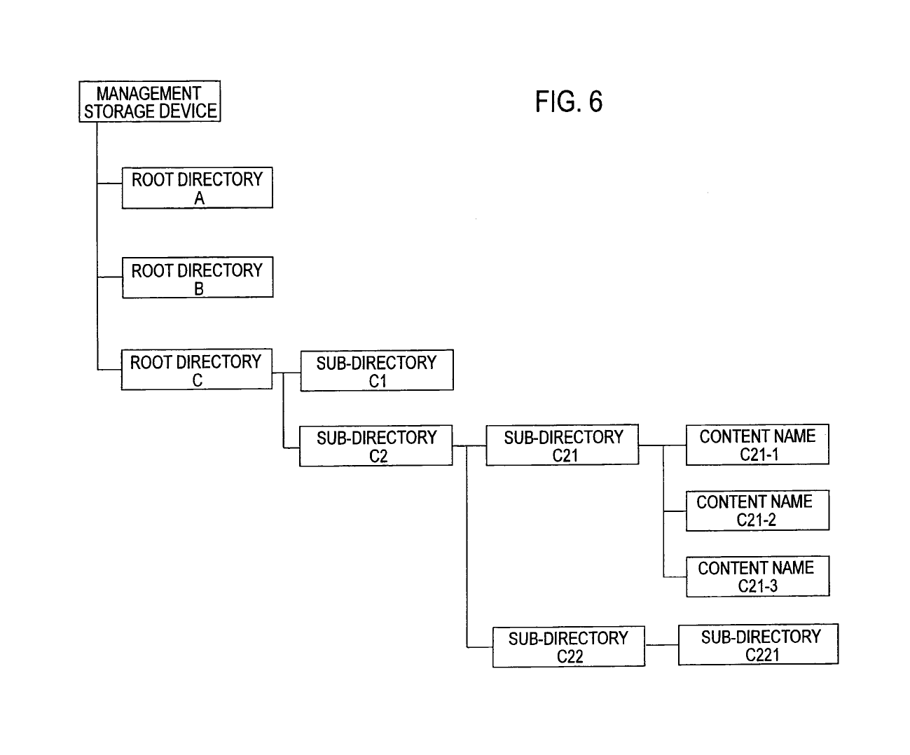

FIG. 7 is a diagram showing process of organizing a local directory.

FIG. 8 is a sequence chart showing an operation of a content management system.

FIG. 9 is a configuration diagram of a name resolution server.

FIG. 10 is a diagram showing the configuration of a content management system according to a second embodiment.

FIG. 11 is a diagram showing a local directory of a management storage device shown in FIG. 10.

FIG. 12 is a sequence chart showing an operation of a content management system according to a second embodiment.

FIG. 13 is a diagram showing a configuration of a content management system according to a third embodiment.

FIG. 14 is a diagram showing a configuration of a directory of a management storage device.

### DESCRIPTION OF EMBODIMENTS

### First Embodiment

Next, a first embodiment of the present disclosure will be described with reference to drawings. Specifically, (1) brief configuration of content management system, (2) configuration of management storage device, (3) configuration of connection storage device, (4) configuration of local playback device, (5) local directory configuration of management storage device, (6) operation of content management system, and (7) operation and effect will be described.

(1) Brief Configuration of Content Management System

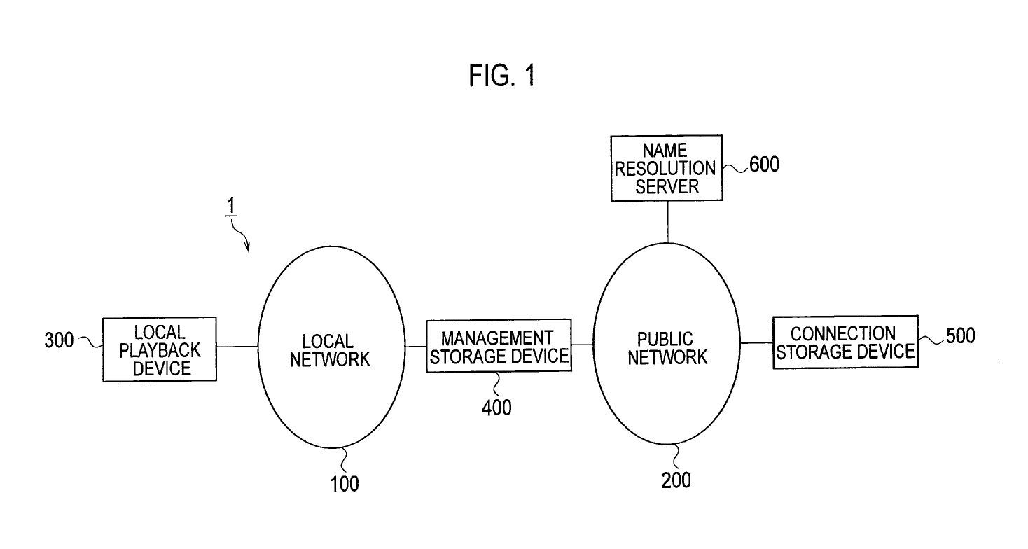

FIG. 1 is a block diagram showing the general configuration of a content management system 1 according to the first embodiment. The content management system 1 includes a local network 100, a public network 200, a local playback device 300 that serves as a local device, a management storage device 400, a connection storage device 500, and a name resolution server 600. The content management system 1 is a system configured to transmit a management content stored in the management storage device 400 and a connection content stored in the connection storage device 500, to the local playback device 300.

The local network 100 is a local network, such as LAN or wireless LAN. The local network 100 is set independent of the public network 200. The public network 200 is, for example, a network such as the Internet.

The local playback device 300 is a device that is connected to the local network 100 and that plays back the content, such as images and sounds. Specifically, the local playback device 300 issues a connection list request and a management list request so as to receive a consolidated content list which consolidates the list of connection contents and the list of management content from the management storage device 400 via the local network 100. The local playback device 300 transmits the connection content data requested by user or the management content request requesting the connection content data and the management content data selected from the received consolidated content list, to the management storage device 400 via the local network 100. The local playback device 300 receives the connection content data or the management content data transmitted in response to the connection content request or the management content request via the local network 100. The local playback device 300 plays back the received connection content or the management content. It is noted that the connection list request and the management list request are requests for acquiring the list of connection contents stored in the connection storage device and the management storage device and content names which are names given for the management storage device.

The management storage device 400 is connected to the local playback device 300 via the local network 100, and is also connected to the connection storage device 500 and the name resolution server 600 via the public network 200. In addition the management storage device 400 functions as a content server providing the management content stored in the management storage device 400 to the local playback device 300, and also functions as a gateway between the local network 100 and public network 200.

When the management storage device 400 acquires the list of connection contents from the connection storage device 500, the management storage device 400 creates a sub-directory indicating the connection storage device 500 in a directory of the predetermined memory area of the management storage device, and arranges the list of connection contents in the lower hierarchy. The management storage device 400 creates the consolidated content list to be transmitted to the local playback device 300 according to a protocol supported by the local playback device 300. Note that the consolidated content list may contain the list of connection contents only, and may consolidate both the list of connection contents and the list of management contents.

The management storage device 400 transmits the created consolidated content list to the local playback device 300. The management storage device 400 receives the connection content request to request the connection content data desired from the consolidated content list or the management content request to request the management content data desired from the consolidated content list, from the local playback device 300 via the local network 100. If receiving the connection content request from the local playback device 300, the management storage device 400 receives the connection content data via the public network 200, and then transmits this received connection content data to the local playback device 300 via the local network 100.

The connection storage device 500 is a content server connected to the public network 200 and provides the connection content stored in the connection storage device 500. The connection storage device 500 receives a connection content request from the local playback device 300 via the local network 100 and public network 200. When the connection storage device 500 receives the connection content request, the connection storage device 500 transmits the connection content data to the local playback device 300 via a public network 200 and a local network 100.

The name resolution server 600 is connected to the connection storage device 500 and management storage device 400 via the public network 200. The name resolution server 600 resolves the names of the connection storage device 500 and management storage device 400.

The name resolution server 600 receives a name resolution request from the management storage device 400. Receiving of the name resolution request, the name resolution server 600 transmits an IP address, which is the name resolution result, to the management storage device 400 via the public network 200.

(2) Configuration of Management Storage Device

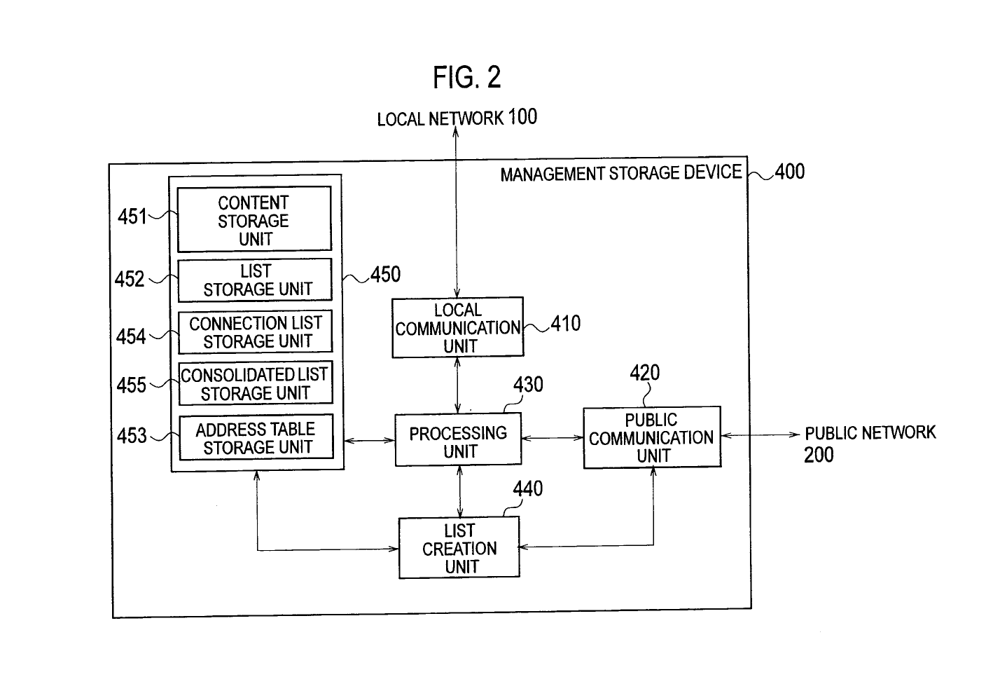

Next, the configuration of the management storage device 400 according to the first embodiment of the present invention will be described with reference to FIG. 2. FIG. 2 shows the management storage device 400 according to the first embodiment. The management storage device 400 includes a local communication unit 410, a public communication unit 420, a processing unit 430, a list creation unit 440, and a storage unit 450.

The local communication unit 410 is an interface configured to connect the management storage device 400 to the local network 100. As the local communication unit 410, an LAN port, a wireless LAN port, etc., are used. The public communication unit 420 is an interface configured to connect the management storage device 400 to the public network 200.

The processing unit 430 executes a process corresponding to a request received from the local playback device 300 via the local communication unit 410 and to selected item information. The processing unit 430 acquires the connection list request, the management list request, etc., from the local communication unit 410, and transmits the consolidated content list to the local playback device 300 in response to the acquired connection list request, etc. Further, the processing unit 430 acquires the desired item information indicating an item desired from the items of the consolidated content list, from the local communication unit 410, and transmits other items or content data in response to the acquired desired item information. Acquiring of the list of connection contents, the processing unit 430 creates a sub-directory indicating the connection storage device in the directory of a predetermined memory area of the management storage device (hereinafter referred to as “local directory”), and arranges the list of connection contents in the lower hierarchy.

It is noted that the management storage device 400 is configured to enable handling of the content in the connection storage device connected via the network in the same way as the content stored in the predetermined memory area of the management storage device. Examples of software fulfilling this function include FUSE (Filesystem In Userspace) in which a file system is provided in the user space, and Dokan.

The list creation unit 440 creates a consolidated content list in response to a content list creation instruction acquired from the processing unit 430, and inputs the created consolidated content list into the storage unit 450.

The storage unit 450 is a storage device, such as HDD, configured to store predetermined information, and includes a content storage unit 451, a list storage unit 452, a connection list storage unit 454, a consolidated list storage unit 455, and an address table storage unit 453.

The content storage unit 451 stores a plurality of contents. The management list storage unit 452 stores the list of the management contents held by the management storage device 400. The connection list storage unit 454 stores the list of connection contents stored in the connection storage device 500. The consolidated list storage unit 455 stores the consolidated content list that consolidates the list of connection contents and the list of the management content stored by the management storage device 400. The address table storage unit 453 stores an address table that correlates the IP addresses, which is the name resolution result acquired from the name resolution server 600, with device names.

(3) Configuration of Connection Storage Device

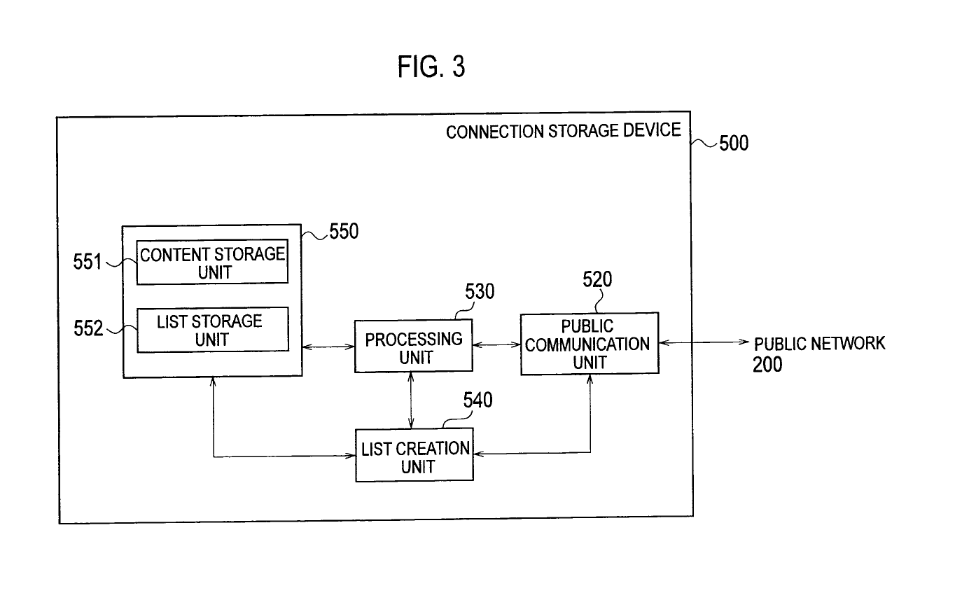

The configuration of the connection storage device 500 according to the first embodiment of the present invention will be described reference to with FIG. 3. FIG. 3 shows the connection storage device 500. The connection storage device 500 includes a public communication unit 520, a processing unit 530, a list creation unit 540, and a storage unit 550.

The public communication unit 520 is an interface configured to connect the connection storage device 500 to the public network 200. The processing unit 530 executes a process corresponding to a request received from the management storage device 400 via the public communication unit 520. The processing unit 530 acquires a connection list request, etc., from the public communication unit 520, and transmits the list of connection contents and the content data to the management storage device 400 in response to the acquisition of the request.

The list creation unit 540 creates the list of connection contents in response to a content list creation instruction acquired from the processing unit 530, and inputs the created list of connection contents into the storage unit 550.

The storage unit 550 is a storage device, such as HDD, configured to store predetermined information, and includes a content storage unit 551 and a list storage unit 552.

(4) Configuration of Local Playback Device

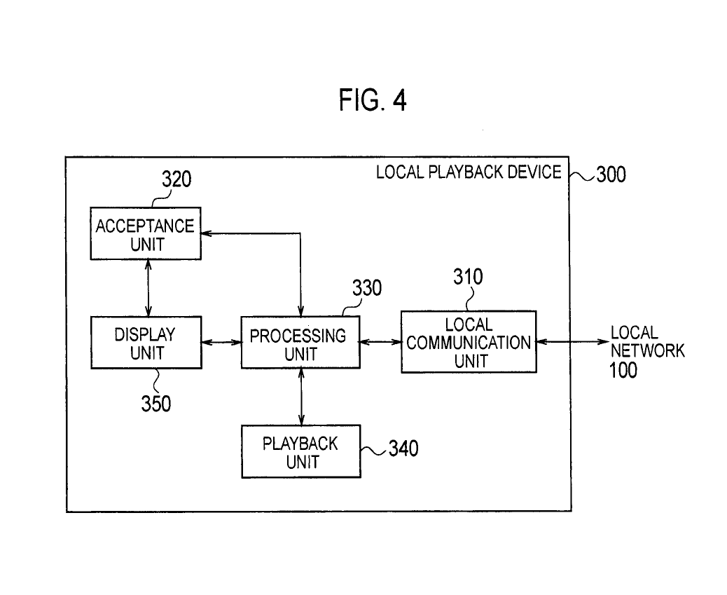

Next, the configuration of the local playback device according to the first embodiment will be described with reference to FIG. 4. FIG. 4 shows the local playback device 300. The local playback device 300 includes a local communication unit 310, an acceptance unit 320, a processing unit 330, a playback unit 340, and a display unit 350.

The local communication unit 310 is an interface configured to connect the local playback device 300 to the local network 100.

The acceptance unit 320 accepts a request for operating the local playback device 300 from outside the local playback device 300. The acceptance unit 320 accepts a list request, for example, and inputs the accepted request into the processing unit 330.

Further, the acceptance unit 320 accepts information for selecting an item in the content list displayed on the display unit 350. Specifically, a list of the contents is configured by one or a plurality of items, and the acceptance unit 320 accepts the information for selecting at least a single item. When the acceptance unit 320 accepts the information for selecting an item, it inputs the selected item information indicating the selected item into the processing unit 330.

Examples of the acceptance unit 320 include a touch panel and/or keyboard, which is a control device that can be operated by the user of the local playback device 300, or a reception unit for a radio signal from a remote controller, or a button that is provided on the outer surface of the local playback device 300 and that is configured to be pressed by the user of the local playback device 300.

The processing unit 330 processes a request and information acquired from the acceptance unit 320 or the local communication unit 310. The processing unit 330 acquires the connection list request or the management list request from the acceptance unit 320, and transmits the acquired connection list request or the management acquired list request to the management storage device 400 via the local communication unit 310. In response to the connection list request or the management list request, the processing unit 330 receives the consolidated content list from the management storage device 400 via the local communication unit 310, and inputs the received consolidated content list into the display unit 350.

The processing unit 330 acquires the selected item information indicating the item selected from the items of the consolidated content list displayed on the display unit 350 from the acceptance unit 320, and transmits the acquired selected item to the management storage device 400 via the local communication unit 310. In response to the selected item, the processing unit 330 receives the other items included in the consolidated content list, or the content data from the management storage device 400 via the local communication unit 310. When the processing unit 330 receives other items, it inputs the received other items into the display unit 350. When the processing unit 330 receives the content data, it inputs the received content data into the playback unit 340.

The playback unit 340 executes a playback process of the content acquired from the processing unit 330. The playback unit 340, for example, is configured by a display unit for displaying images and data, and by a speaker for outputting the sounds.

The display unit 350 displays the consolidated content list, Specifically the items of the consolidated content list, acquired from the processing unit 330.

Although not shown in the figure, the local playback device 300, the management storage device 400, and the connection storage device 500 may also include a program holding unit for holding a program causing a CPU to execute a process performed by the public communication unit, the local communication unit, and the processing unit. Recording media such as RAM, ROM, hard disks, flexible disks, compact disks, IC chips, and cassette tapes are used as the program holding unit.

(5) Local Directory Configuration of Management Storage Device

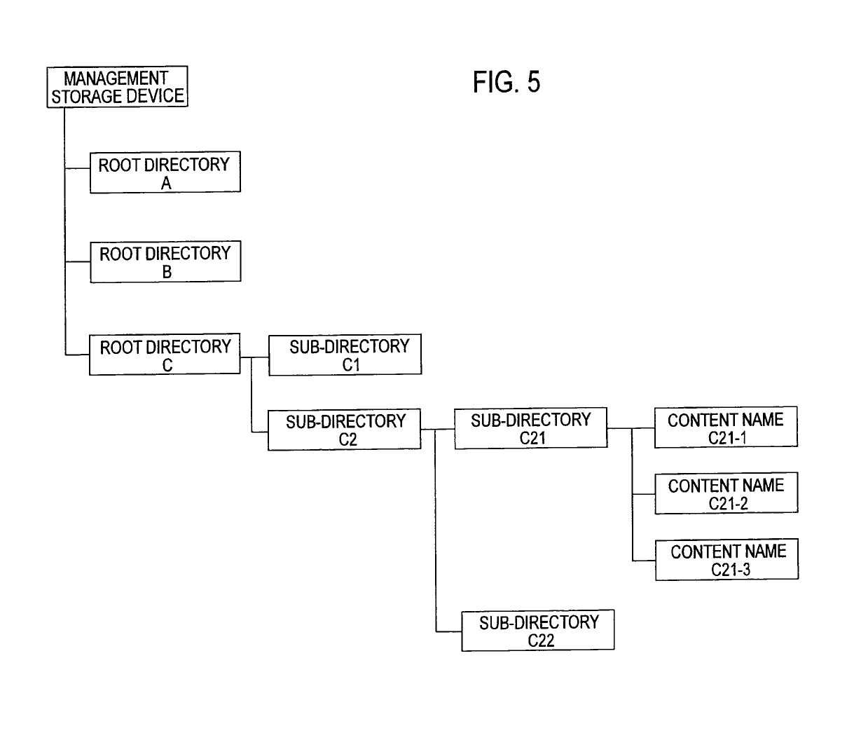

Next, the local directory configuration of the management storage device will be described. When the management storage device 400 acquires the list of connection contents, it arranges the list of connection contents in the lower hierarchy of a root directory. FIG. 5 shows the configuration before receiving the list of connection contents. It is noted that for the sake of convenience, a display of root directories, sub-directories, and contents are omitted except one directory in FIG. 5.

The local directory has a tree structure in which a plurality of items are arranged in hierarchies, and includes a plurality of root directories (root directories A, B, and C). Sub-directories are arranged in the lower hierarchy of each root directory. For example, sub-directories C1 and C2 are arranged in the lower hierarchy of the root directory C. The sub-directory C1 stores the content for which access from other users on the network is restricted. On the other hand, the sub-directory C2 stores the content for which access from other users on the network is not restricted (hereinafter referred to as “shared content”).

The sub-directories C21 and C22 are arranged in the lower hierarchy of the sub-directory C2. The list of shared contents (content names C21-1 to C21-3) stored in the management storage device 400 is arranged in the sub-directory C21, and the list of shared contents in another storage device connected via the network (for example, connection storage device 500) is arranged in the sub-directory C22.

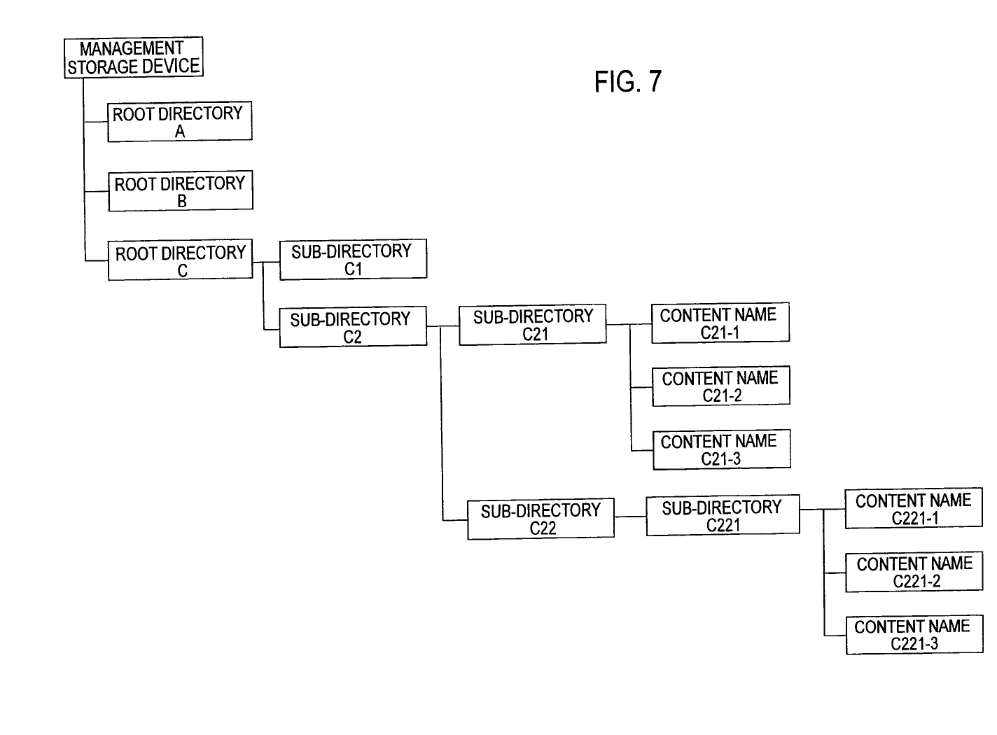

Also, when the management storage device 400 acquires the list of connection contents from the connection storage device 500, it creates the sub-directory C221 indicating the connection storage device, which is a transmission source of the list as shown in FIG. 7. As shown in FIG. 7, a list of connection contents is arranged in the lower hierarchy of the sub-directory C221. Specifically, lists of connection content C221-1 to C221-3 are arranged in the lower hierarchy of the sub-directory C221.

(6) Operation of Content Management System

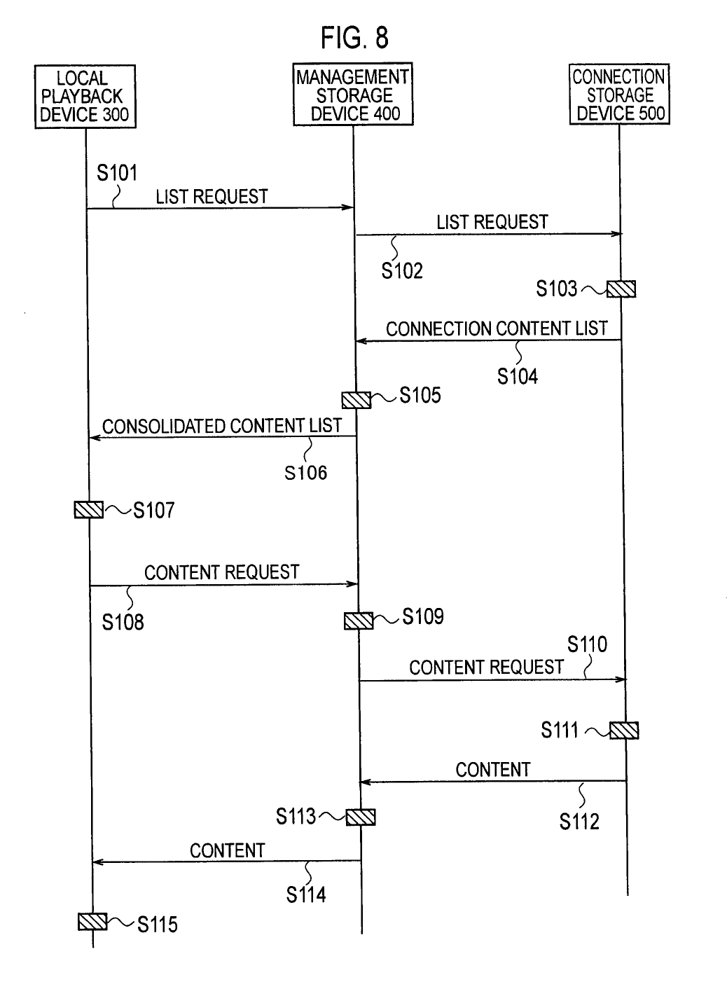

The operation of the content management system according to the first embodiment of the present invention will be described below with reference to FIG. 8. FIG. 8 is a sequence diagram showing the operation of the content management system 1 up to the transmission of the content along with transmitting a list of the contents to the local playback device 300, in response to the list request from the local playback device 300.

In S101, the local playback device 300 transmits a list request to the management storage device 400. In S102, the management storage device 400 transmits a connection list request for acquiring the list of connection contents, to the connection storage device 500.

In S103, the connection storage device 500 creates a list of connection contents including the content name stored in the connection storage device 500. In S104, the connection storage device 500 transmits the list of connection contents created in S104 to the management storage device 400. The management storage device 400 receives the list of connection contents from the connection storage device 500. In this case, the received list of connection contents is described in a language format supported by the connection storage device 500, such as HTML, XML, and JSON.

In S105, the management storage device 400 receives the list of connection contents, creates the sub-directory C221 indicating the connection storage device 500 in the directory of a predetermined memory area of the management storage device 400, and then arranges the list of connection contents in the lower hierarchy.

The management storage device 400 creates a consolidate s content list that consolidated the list of management content with the list of connection contents, which is the consolidated content list by the protocol according to the local playback device 300.

Next, in S106, the management storage device 400 transmits the consolidated content list of to the local playback device 300. At this point, the management storage device 400 transmits the list with a protocol supported by the local playback device 300. In S107, the local playback device 300 displays the consolidated content list received from the management storage device 400, and accepts the selection of content by user. In S108, the local playback device 300 transmits a connection content request containing the selected connection content information to the management storage device 400.

In S109, the management storage device 400 extracts the selected content name from the connection content request. The selected content name is included in the list of connection contents, then the management storage device 400 transmits a content request requesting the corresponding content to the connection storage device 500 (S110). It is noted that at this point, if the request is for acquiring the content stored in the management storage device 400, then the corresponding content is transmitted to the local playback device 300.

In S111, the connection storage device 500 receives the connection content request, and reads out the selected connection content. In S112, the connection storage device 500 transmits the read-out connection content data to the management storage device 400. In S113, the management storage device 400 stores the connection content data that received from the connection storage device in the content storage unit 451. In S114, the management storage device 400 transmits the connection content data that stored in the content storage unit 451 to the local playback device 300. In S115, the local playback device 300 plays back the connection content data that received from the management storage device 400.

7) Operation and Effect

According to the content management system 1 according to the first embodiment of the present invention, when the management storage device 400 receives the list of connection contents from the connection storage device 500, it converts it to a protocol supported by the local playback device 300, and transmits a consolidated content list including the list of connection contents. Thus, the list of connection contents is acquired in the local playback device 300 connected to the management storage device 400 via the local network, and the connection content can be used.

Further, the management storage device 400 arranges the list of connection contents acquired from the connection storage device 500 in the lower hierarchy of the sub-directory indicating the connection storage device 500. The local playback device 300 can acquire and use the connection content stored in the connection storage device 500 and the management content stored in the management storage device 400 without differentiating the two.

Further, the first embodiment is configured such that the connection content data is transmitted to the local playback device 300 in response to the request from the local playback device 300, but it may also be configured such that the connection storage content data is deleted, or the name of the connection storage content is changed in response to the request from the local playback device 300.

Specifically, when the management storage device 400 receives a request for deleting the connection content data from the local playback device 300, a request for deleting the corresponding connection content data is transmitted from the management storage device 400 to the connection storage device 500. Also, when the management storage device 400 receives a deletion completed notification from the connection storage device 500, the corresponding content is deleted from the list of connection contents stored in the predetermined memory area of the management storage device 400, and at the same time, a request for deleting the list of connection contents from which the corresponding content is to be deleted is transmitted to the local playback device 300. In this way, the deletion of the connection content data can be executed, and the consolidated content list in the management storage device 400 and local playback device 300 can be synchronized with the list of connection contents.

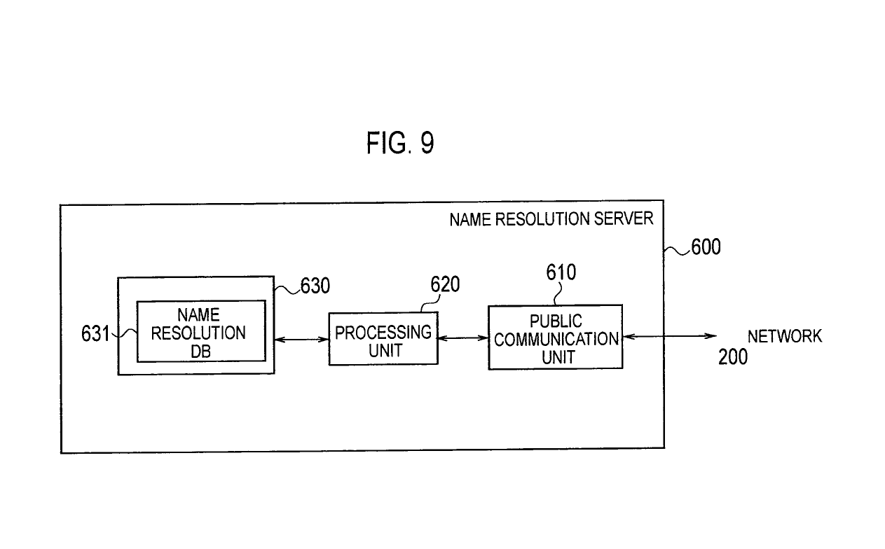

t is noted that the first embodiment describes the case when the management storage device acquires the IP address indicating the connection destination of the connection storage device beforehand; however, the configuration may also be such where if the management storage device does not acquire the IP address indicating the connection destination of the connection storage device, then the name resolution is performed via the name resolution server 600. FIG. 9 shows the name resolution server. The name resolution server 600 includes a public communication unit 610, a processing unit 620, and a storage unit 630.

The public communication unit 610 is an interface configured to connect the name resolution server 600 to the public network 200. The processing unit 620 executes a process corresponding to a request received from the management storage device, etc. via the public network. For example, the processing unit 620 acquires the name resolution request from the public communication unit 610, extracts the IP address as the name resolution result of the corresponding storage device in response to the name resolution request, and executes the name resolution process.

The storage unit 630 is a storage device, such as HDD, configured to store predetermined information. The storage unit 630 includes a name resolution database 631. In the name resolution database 631, the device name of each storage device and the IP address, which is the address indicating the destination, are recorded in an associated manner.

Next, the name resolution process will be described in detail. To transmit a connection list request to the connection storage device 500, the management storage device 400 transmits a name resolution request for the connection storage device 500 to the name resolution server 600. Specifically, it transmits a message including the device name of the connection storage device 500 and the acquisition request of the IP address. The name resolution server 600 receives the name resolution request, and extracts the IP address indicating the connection destination of the connection storage device 500 from a name resolution database 631.

The name resolution server 600 transmits the IP address to the management storage device 400. When the management storage device 400 receives the IP address of the connection storage device 500 from the name resolution server 600, it stores the IP address of the connection storage device 500 in the address table storage unit 453. In this way, the management storage device 400 and the connection storage device 500 can be connected.

### Second Embodiment

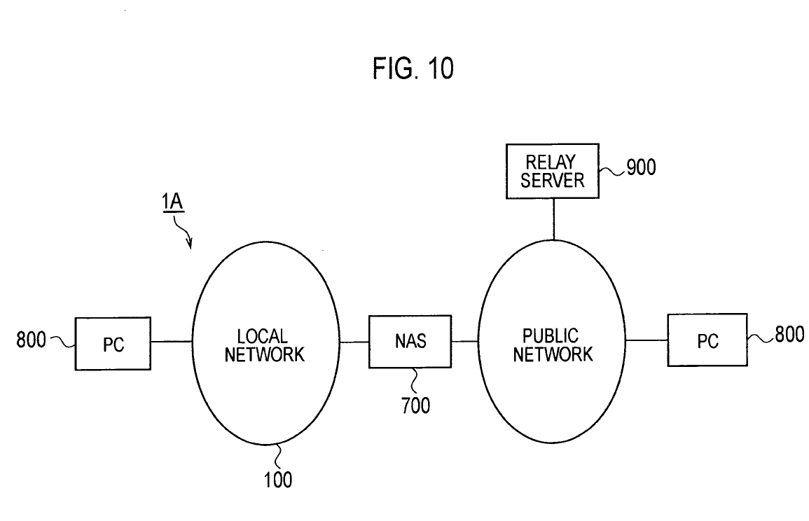

Next, the content management system according to a second embodiment will be described in detail with reference to FIG. 10. FIG. 10 shows a content management system 1A according to the second embodiment. The content management system 1A according to the second embodiment includes NAS 700 as a connection storage device, PC 800 as a management storage device, and a relay server 900. It is noted that in the second embodiment, the explanation of the configuration similar to that in the first embodiment will be omitted.

The PC 800 is what is called a mobile terminal, is configured to be movable, and may be within the same LAN (Local Area Network) as NAS or outside the same LAN as NAS. If the PC 800 and the NAS 700 are within the same LAN, the NAS 700 and the PC 800 can communicate via the local network, and if the NAS 700 and the PC 800 are outside the same LAN, these can communicate via a public network through the specification of a global IP address.

The NAS 700 includes a storage unit for storing a plurality of contents. PC 800 can use the connection content stored in the NAS 700 by accessing the relay server 900 via a public network.

The relay server 900 functions (hereinafter referred to as “Web access function”) as a relay between an NAS and another device so that such a device as a mobile phone or a PC can access NAS 700 via a public network from outside so as to effectuate the download and upload of connection contents in the NAS 700 The NAS 700 is predetermined as to whether or not a Web access to it is permitted, and if permitted, accessible connection contents are preselected By accessing the relay server 900 from the PC 800, the list of connection contents can be acquired with the Web access functionality.

In the PC 800, the list of connection contents is arranged in the lower hierarchy of the root directory D of the local directory. In other words, in the second embodiment, the root directory D functions as the sub-directory indicating NAS 700.

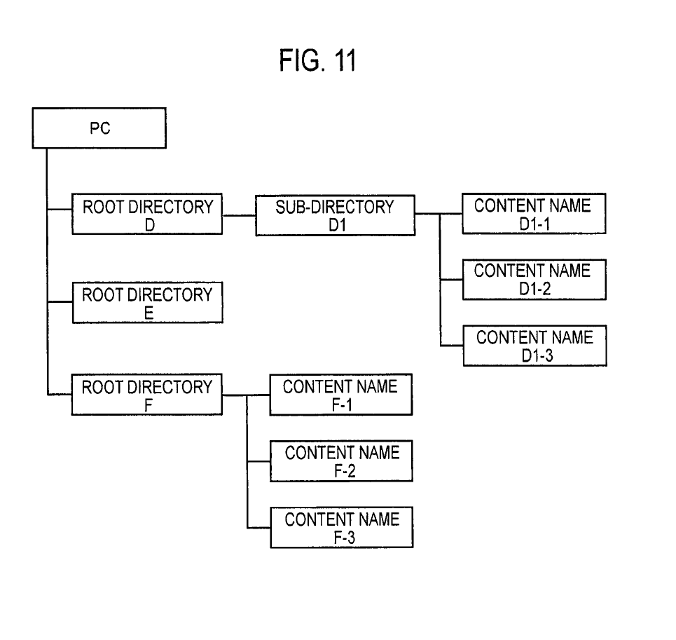

FIG. 11 shows the local directory of PC 800. The local directory has a tree structure in which a plurality of items is arranged in hierarchies. The local directory of the PC 800 has a plurality of root directories D, E, and F. Sub-directories are arranged in the lower hierarchy of each root directory. The root directory F functions as a sub-directory indicating NAS 700 which PC 800 connects to via a public network, in which the list of shared contents of the NAS 700 (content name F-1 to F-3) is arranged.

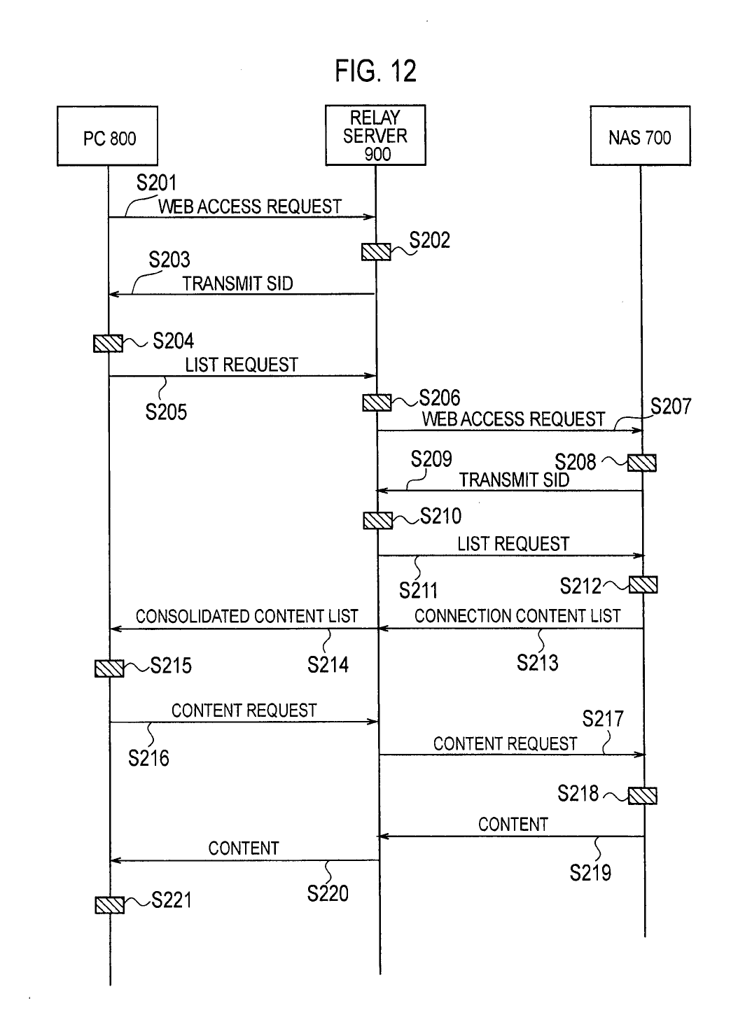

Next, the operation of the content management system 1A according to the second embodiment will be described in detail with reference to FIG. 12. FIG. 12 is a sequence diagram showing the operation when the PC 800 is connected to the NAS 700 via a public network, in which the PC 800 and the NAS 700 are connected via the relay server 900.

First of all, in S201, the PC 800 transmits a Web access request to the relay server 900. Specifically, the PC 800 transmits the PC's ID and password to the relay server 900. Next, the relay server 900 executes the authentication process (S202).

When the relay server 900 receives the ID and password, it executes the authentication process for the ID and password. If the ID and password is authenticated, the relay server 900 issues a security identifier (SID), and transmits the SID to PC 800. On the other hand, if the ID and password is not authenticated, for example, an error process is executed. An example of an error process includes transmitting a message to the PC 800 prompting the re-transmission of the ID and password (S203). Next, PC 800 saves the received SID in the storage unit (S204). This explains the authentication process.

Next, the PC 800 accepts the selection of the root directories D, E, and F by the user. The user operating the PC 800 selects the root directories D, E, and F as selection of the list of contents in which the user desires to acquire. If the root directory F is selected, then the PC 800 transmits the connection list request for acquiring the list of connection contents of the NAS 700 and the SID to the relay server 900 (S205). The relay server 900 stores each NAS device name and IP address in an associated manner, and extracts the IP address of the NAS 700 corresponding to the device name to be connected to (S206). Then, in order to transmit a connection list request to the NAS 700, the relay server 900 transmits a Web access request to the NAS 700 (S207). The NAS 700 and the relay server 900 execute the authentication process. The authentication process is executed next. It is noted that the authentication process (S208 to S210) is the same as the above-mentioned authentication process. Therefore, its explanation has been omitted. Next, the relay server 900 transmits the connection list request to the NAS 700 (S211). This connection list request contains the SID acquired by the relay server 900 during the authentication process.

In S212, when the NAS 700 received the connection list request, it determines based on SID whether or not the relay server is permitted access to the folder that stores the demanded content based on the SID. When the relay server 900 is not permitted access to the corresponding folder in S212, the error process is executed. On the other hand, When the relay server 900 is permitted access to the corresponding folder in S212, a list of connection contents, which is a list of shared contents is created and the list of connection contents is transmitted to the relay server 900 (S213).

In S214, the relay server 900 transmits the list of connection contents of the NAS 700 to the PC 800. In S215, the PC 800 arranges the list of connection contents of the NAS 700 in the lower hierarchy of the root directory F. Further, the PC 800 displays the list of connection contents (content name F-1 to F-3) of the NAS 700, and accepts the selection of the displayed content item by the user or other terminal.

In S216, the PC 800 transmits the connection content request requesting the data of the selected item (for example, content name F-1) to the relay server 900. In S217, the relay server 900 transmits the connection content request to the NAS 700. In S218, the NAS 700 reads out the connection content data corresponding to the connection content request. In S219, the NAS 700 transmits the read-out connection content data to the relay server 900. In S220, the relay server 900 transmits the received connection content data to the PC 800. In S221, the relay server 900 stores the connection content data of the NAS 700.

As described above, according to the second embodiment, the connection content data stored in the NAS 700 can be used as the content data stored in a predetermined memory area of the PC 800. Thus, whether the content data is stored in the PC 800 or the content data is stored in the NAS 700, it can be handled in the same way in the PC 800, and the operability of the PC 800 can be improved. Further, even if the PC 800 is within the LAN, the same effect can be obtained by configuring in a way that the list of connection contents and the connection content data of the NAS 700 are acquired via the local network.

### Third Embodiment

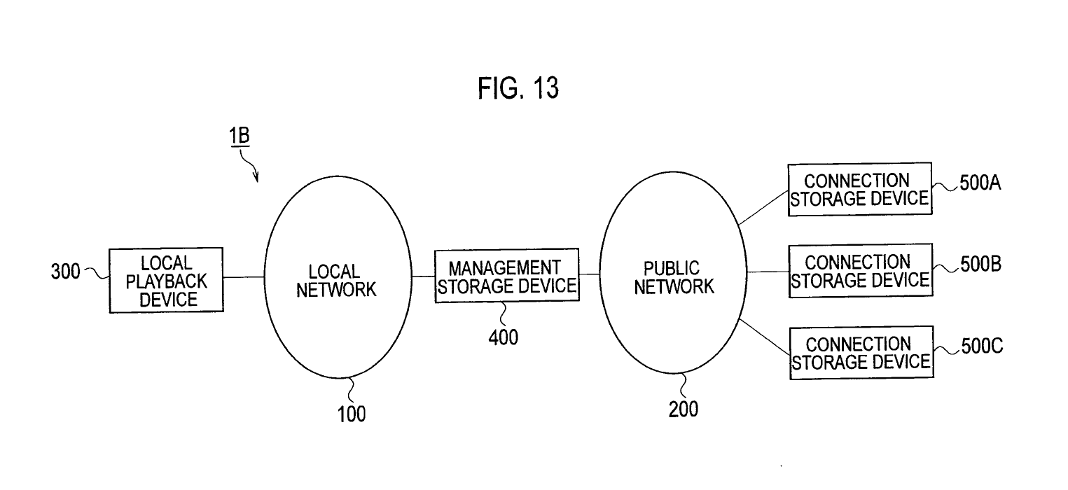

Next, the content management system according to a third embodiment will be described in detail with reference to FIG. 13. FIG. 13 shows a content management system 1B according to the third embodiment. Similarly to the first embodiment, the content management system 1B according to the third embodiment includes a management storage device 400, a local playback device 300, and a connection storage device 500. Unlike the content management system of the first embodiment, the content management system 1B according to the third embodiment includes a plurality of connection storages 500A, 500B, and 500C, and the management storage device 400 does not include the memory area for storing the content in the management storage device 400.

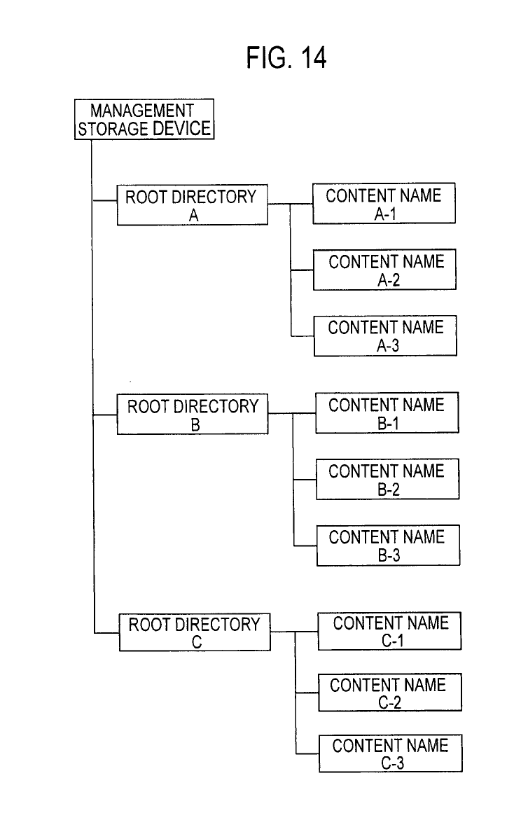

FIG. 14 shows the directory configuration of the management storage device 400. The directory of the management storage device 400 includes the root directories A, B, and C corresponding to a plurality of connection storage device s. Each root directory A, B, and C functions as a directory corresponding to the connection storage device s 500A, 500B, and 500C. Also, the list of connection contents acquired from each connection storage device is arranged in the lower hierarchy of each root directory A, B, and C.

The management storage device 400 acquires the list of connection contents from a plurality of connection storage device s, and stores the acquired connection content lists in a predetermined memory area of the management storage device 400. The management storage device 400 transmits the consolidated content list that consolidates a plurality of connection content lists to the local playback device 300.

According to such a content management system, when the management storage device 400 does not have the memory for storing the content, the content of the connection storage device connected to the management server 400 via a public network can be used in the local playback device 300 connected to the management storage device 400 via a local network.

The desired embodiments of the present invention are explained above, but the present invention is not limited to these, and various modifications and changes are possible within the scope of its gist. For example, the authentication process is executed by transmitting a Web access request to the relay server from PC 800 in the second embodiment; however, the authentication process may be executed in connection storage device and the management storage device of the first embodiment, or the authentication process may be executed in the name resolution server.

Further, from the viewpoint of security reservation, the SID may be invalidated after a lapse of a certain time period. In this way, it is possible that the authentication process is automatically executed again, when the authentication is not possible, for example when a validity period of the SID included in the list request expires. When the authentication process is automatically executed again, it is possible to simplify the frequency of operation by the user, and it is possible to realize a prompt process.

What is claimed is:

1. A content management method, comprising:
transmitting from a management storage device a connection list request that requests a list of connection contents stored in a connection storage device connected to the management storage device via a public network to the connection storage device;
receiving by the connection storage device the connection list request, and transmitting the list of connection contents;
receiving at the management storage device the list of connection contents, and arranging the received list of connection contents in a lower hierarchy of a directory indicating the connection storage device arranged in a lower hierarchy of a directory indicating the management storage device; and
converting at the management storage device a protocol corresponding to the connection storage device into a protocol corresponding to a local device to be connected via a local network with the management storage device, and transmitting a consolidated content list including the list of connection contents to the local device.

2. A content management method, comprising:
transmitting from a management storage device a connection list request that requests a list of connection contents stored in a connection storage device connected to the management storage device via a public network to the connection storage device;
receiving by the connection storage device the connection list request, and transmitting the list of connection contents;
receiving at the management storage device the list of connection contents, and arranging the received list of connection contents in a lower hierarchy of a directory indicating the connection storage device arranged in a lower hierarchy of a directory indicating the management storage device; and
converting at the management storage device a protocol corresponding to the connection storage device into a protocol corresponding to a local device to be connected via a local network with the management storage device, and transmitting a consolidated content list that consolidates the list of connection contents and the list of management contents stored in the management storage device.

3. The content management method according to claim 1 further comprising:
transmitting by the local device a connection content request that requests connection content data included in the consolidated content list, to the management storage device;
receiving at the management storage device the connection content request, and transmitting the received connection content request to the connection storage device;
receiving at the connection storage device the connection content request, and transmitting a requested connection content data to the management storage device; and
receiving at the management storage device the connection content data, and transmitting the received connection content data to the local device.

4. The content management method according to claim 2, further comprising:
transmitting by the local device a connection content request that requests connection content data included in the consolidated content list, to the management storage device;
receiving at the management storage device the connection content request, and transmitting the received connection content request to the connection storage device;
receiving at the connection storage device the connection content request, and transmitting a requested connection content data to the management storage device; and
receiving at the management storage device the connection content data, and transmitting the received connection content data to the local device.

5. The content management method according to claim 2, further comprising:
transmitting from the local device a management content request that requests management content data contained in the consolidated content list, to the management storage device; and
receiving by the management storage device the management content request, and transmitting the requested management content data to the local device.

6. A content management method according to claim 1, further comprising:
transmitting from the management storage device a name resolution request to acquire an address of the connection storage device to a name resolution server for executing a name resolution with the connection storage device, in response to the connection list request; and
transmitting from the name resolution server the address of the connection storage device, which serves as a name resolution result, to the management storage device, in response to the name resolution request.

7. A content management method according to claim 2, further comprising:
transmitting from the management storage device a name resolution request to acquire an address of the connection storage device to a name resolution server for executing a name resolution with the connection storage device, in response to the connection list request; and
transmitting from the name resolution server the address of the connection storage device, which serves as a name resolution result, to the management storage device, in response to the name resolution request.

8. The content management method according to claim 1, further comprising:
transmitting from a management storage device a connection list request that requests a list of connection contents stored in a connection storage device connected via a public network to the management storage device to a plurality of the connection storage devices;
receiving at the respective plurality of the connection storage devices the connection list request, and transmitting the list of connection contents to the management storage device;
making at the management storage device each list of connection contents, in a lower hierarchy of a directory indicating the connection storage device arranged in a lower hierarchy of a directory indicating the management storage device;
creating by the management storage device a consolidated content list that consolidates the plurality of connection content lists; and
converting at the management storage device a protocol corresponding to the connection storage device into a protocol corresponding to a local device connected via a local network to the management storage device, and transmitting the consolidated content list to the local device.

9. A management storage device connected to enable communication via a public network with a connection storage device and connected to enable communication via a local network with a local device, comprising:
a connection list request reception unit that receives a connection list request that requests a list of contents stored in the connection storage device, from the local device;
a list of connection content acquisition unit that acquires the list of connection contents from the connection storage device, in response to the connection list request;
a directory organization unit that arranges the list of connection contents in a lower hierarchy of a directory indicating the connection storage device arranged in a lower hierarchy of a directory indicating the management storage device; and
a content list transmission unit that converts a protocol corresponding to the connection storage device into a protocol corresponding to the local device, and transmits the list of connection contents to the local device.

10. The management storage device according to claim 9, further comprising a record holding unit that temporarily records the list of connection contents.

11. A non-transitory content management computer program product having stored therein instructions that when executed by a processing circuit cause the processing circuit to communicate via a public network with a connection storage device and communicate via a local network with a local device, and implement a device comprising:
a connection list request reception unit that receives a connection list request that requests a list of contents stored in the connection storage device, from the local device;
a list of connection content acquisition unit that acquires the list of connection contents from the connection storage device, in response to the connection list request;
a directory organization unit that arranges the list of connection contents in a lower hierarchy of a directory indicating the connection storage device arranged in a lower hierarchy of a directory indicating the management storage device; and
a content list transmission unit that converts a protocol corresponding to the connection storage device into a protocol corresponding to the local device, and transmits the list of connection contents to the local device.

12. The non-transitory content management computer program product of claim 11, wherein the device further implements a record holding unit that temporarily records the list of connection contents.
